(19) United States
(12) Patent Application Publication
(10) Pub. No.: US 2018/0190251 A1
(43) Pub. Date: Jul. 5, 2018

(54) METHOD TO CONTROL THE TIMBRE OF A TARGET STRINGED INSTRUMENT IN REAL-TIME

(71) Applicant: MODERN ANCIENT INSTRUMENTS NETWORKED AB, 121 54 Johanneshov (SE)

(72) Inventors: Michele Benincaso, Johanneshov (SE); Agostino De Angelis, Lucera (IT); Carlo Fischione, Stockholm (SE); Luca Turchet, Copenhagen (DM); Stephano Zambon, Nacka (SE)

(21) Appl. No.: 15/736,389

(22) PCT Filed: May 29, 2016
(86) PCT No.: PCT/SE2016/050494

§ 371 Date: Dec. 14, 2017

(30) Foreign Application Priority Data
Jun. 22, 2015 (SE) 1530095-7

(51) Int. Cl. G10H 1/045; G10H 1/00; G10H 3/18; G10H 3/26

(52) U.S. Cl. CPC G10H 1/045; G10H 1/0058; G10H 3/186; G10H 2230/075; G10H 2210/265; G10H 2220/525; G10H 3/26

(57) ABSTRACT

A method and process to set the parameters of a Control Algorithm and to synthesize and generate a variety of sounds and vibration that are normally not available on a specific acoustic stringed instrument are disclosed. The technical problems of generating a different timbre, sound and vibration of a stringed acoustic instrument (Controlled Instrument) in real time are solved. The invention describes a process (Cloning Procedure) where specific set of parameters needed to imitate a target instrument are defined; The imitation of the Target Instrument's timbre on the Controlled Instrument is performed by the Control Algorithm which employs two digital Linear-Time-Invariant systems to drive the actuators based on by controlling the actuators with a couple of digital Linear-Time-Invariant systems that receive the vibration signal from the measurement apparatus. The process can be optionally deactivated, thus having the Controlled Instrument acting as a traditional acoustic instrument.

### 1 BACKGROUND OF THE INVENTION

### 1.1 Field of the Invention

The present invention relates to augmented stringed musical instruments, i.e., conventional acoustic stringed instruments enhanced with electrical sensors and actuators.

### 1.2 Background Art

The internet of things revolution has impacted a variety of fields and industries, including acoustic stringed instruments. As a result new augmented instruments or prototypes were introduced. Prior art shows several examples of augmented stringed musical instruments and different applications (US 20140224099 A1; US20120007884; US2002/0005108A1; PCT/GB2000/000769; U.S. Pat. No. 6,320,113 B1; U.S. Pat. No. 8,389,835 B2).

The problem addressed relates to the need of players of acoustic stringed instruments to enhance the range of sound, timbre and vibration of their instrument in order for instance to replicate the resonance or other characteristics of another instrument or to recreate special sound or vibration effects, or to modify such effects during the act of playing. The existing technologies available to acoustic stringed instruments allow to create special effects only by acting on the physical feature of the instrument, i.e. the size, or the shape or the thickness of the sounding board, the material of the different instrument's parts, or the size of the strings, which is obviously an operation that can be done exclusively before the act of playing and which requires often a recrafting of the instrument.

### SUMMARY OF THE INVENTION

The present invention provides an innovative solution to the described need. The invention describes a method and a process to synthesize a desired vibration or timbre or sound of another instrument (Target Instrument) in real time. The solution will make possible, for instance, to make vibrate a stringed instrument (Controlled Instrument) similarly to the timbre of another stringed instrument (Target Instrument), this last one having different features and a different timbre than the Controlled Instrument. The capability to control and modify such effects will be accomplished in real-time while the musician is actually playing the instrument.

The Controlled Instrument and the Target Instrument are stringed musical instruments that include a soundboard and/or a sound box, and a bridge. A measurement apparatus of the instruments vibration is placed under the bridge of the Controlled Instrument, and two actuators are attached respectively to the main resonating surface and a secondary, mechanically uncoupled tonal chamber. The signals driving the actuators are determined by a Control Algorithm. While the presence of a secondary actuator does not improve the generality of the system, its contribution may become fundamental in practice when using one of the empiric estimation techniques hereby proposed.

The Control Algorithm imitates the Target Instrument by feeding the actuators with a processed version of the Controlled Instrument's string and soundboard vibration detected by the measurement apparatus while the instrument is being played. The Cloning Procedure gives the parameters of the Control Algorithm when such an algorithm has to control the Controlled Instrument so it sounds similar to the Target Instrument. However, the Control Algorithm is not restricted to only impose the reproduction of a Target Instrument. The Control Algorithm can make the Control Instrument sound in other desired manners by choosing the Control Algorithm parameters.

The patent US2002/0005108A1 describes several sensors and actuators embedded in a musical instrument, which are capable to control the sound emission, among other features, via a DSP (Digital Signal Processing) module. The DSP unit implements the sound controller. The Control Algorithm of the present invention needs the sensor/DSP/actuator architecture described in the patent US2002/0005108A1. However, such a patent does not specify neither the Cloning Procedure, nor the Control Algorithm, which are instead the inventive steps of the present document. The patent PCT/GB2000/000769 has identical claims to the previous patent US2002/0005108A1 for what concerns the architecture sensor/controller unit/actuator. Analogously, the function of the processing unit is different from the Control Algorithm. The expired so patent U.S. Pat. No. 6,320,113 B1 is similar to the architecture sensor/controller unit/actuator of the patent US2002/0005108A1. It describes a system that provides sound control for an acoustic musical instrument comprising actuators, sensors, and closed-loop transfer functions. A sensor is configured to generate sensed signals based on vibrations from a structure. The sensed signals are input to a controller that processes output signals. The output signals are fed to an actuator that alters the sound of the acoustic instrument. The differences of the present invention compared to this patent are the same as the differences compared to patent US2002/0005108A1. In addition, the controller unit is posed outside the instrument as well as the location of the actuators is different from that of the os present invention. The U.S. Pat. No. 8,389,835 B2 has identical claims to the previous patent US2002/0005108A1 for what concerns the architecture sensor/controller unit/actuator. However, the controller unit is less advanced than patent US2002/0005108A1 in that it does not seem to be a DSP. The differences of the present invention compared to this patent are the same as the differences compared to patent US2002/0005108A1.

### 3 DESCRIPTION OF THE DRAWINGS

FIG. 1.1: is a perspective view of a stringed instrument illustrating its nomenclature.

FIG. 1.2: is a diagrammatic view of the Controlled Instrument showing the location of the sensors and actuators, the separate tonal chamber, and the control system.

FIG. 1.3: illustrates the overall calibration setup for the Cloning Procedure.

FIG. 1.4: is a block diagram of the control system in an augmented instrument.

FIG. 1.5: is the input/output description of the Target Instrument in the frequency domain.

FIG. 1.6: is a block diagram describing the functions involved during the optimization procedure.

### 4 DETAILED DESCRIPTION

The method and process of the present invention is described by referring to the figures, which are just an exemplification of the preferred execution and do not limit the invention to just such forms of representation.

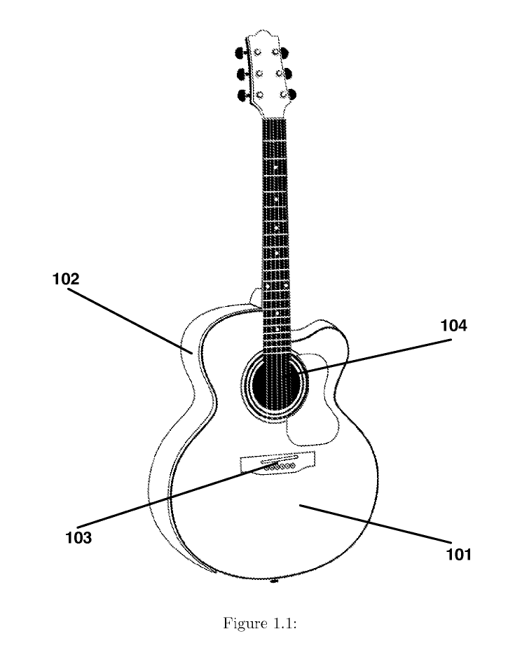

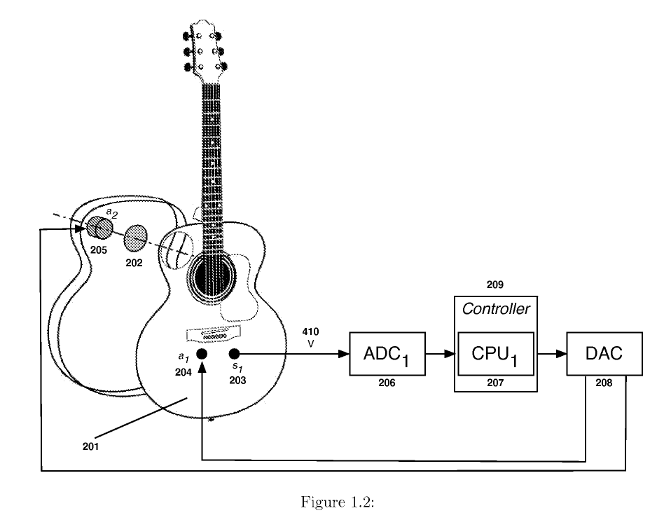

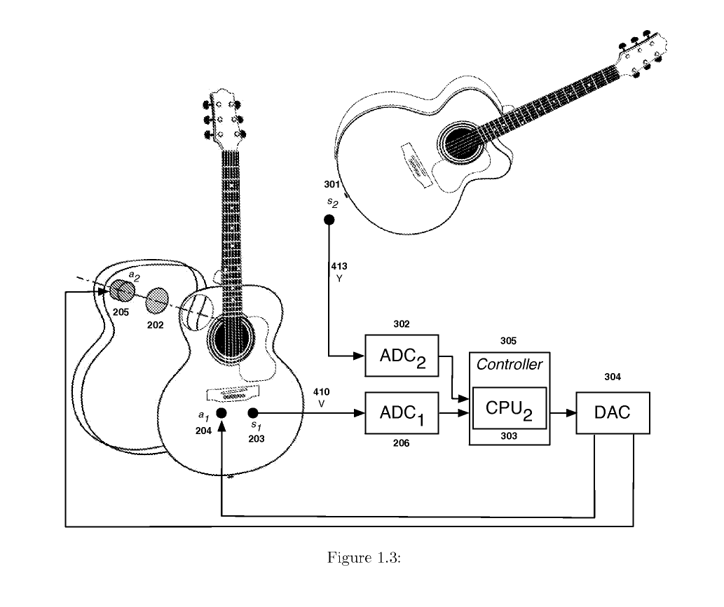

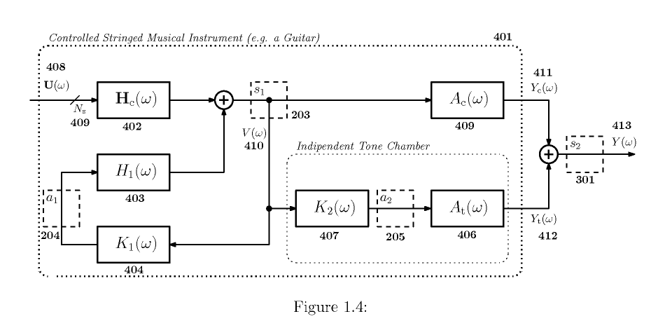

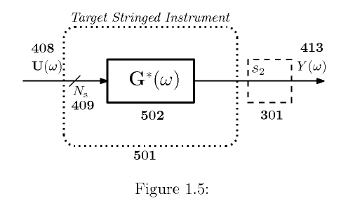

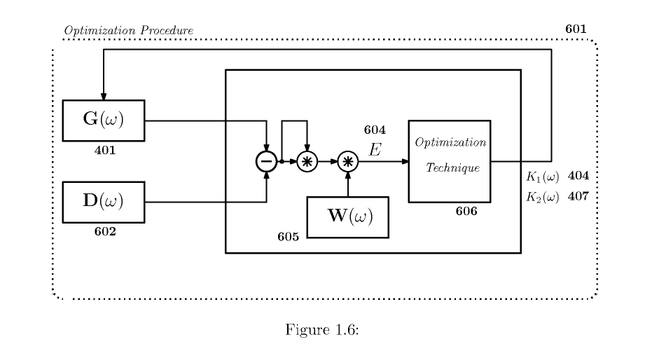

The Target Instrument is any instrument composed of a radiating body (i.e., a soundboard (101) and/or a sound box (102)), a bridge (103), and strings (104) (see FIG. 1.1).

The Controlled Instrument is composed of the following components (see FIG. 1.2):
1. A radiating body (i.e., a soundboard (101) and/or a sound box (102)), a bridge (103), and strings (104). The radiating body is divided into a principal part (201) and a secondary tonal chamber (202) of smaller dimensions that is mechanically uncoupled from the rest of the instrument.
2. A velocity measurement apparatus s₁ (203), such as an accelerometer or a piezoelectric contact microphone, placed in the principal part of the body (201) in a position close to the strings bridge (103).
3. A force actuator (or other vibratory device capable of providing mechanical excitation) a₁ (204) placed in the principal part of the body (201) close to the measurement apparatus s₁ (203).
4. A force actuator (or other vibratory device capable of providing mechanical excitation) a₂ (205) placed in the secondary tone chamber (202).
5. A generic Central Processing Unit (CPU1) (207) used to implement the real-time control algorithm.
6. A single-channel Analog-to-Digital converter (ADC1) (206) used to sample and quantize the signal coming from the sensor s₁ (203) in order to be processed by the CPU1 (207).
7. A multi-channel Digital-to-Analog converter (DAC) (208) used to drive both the actuators a₁ (204), a₂ (205) from CPU1 (207).

The parameters of the Controlled Instrument are calibrated using a calibration setup that consists of the following items (see FIG. 1.3):
1. An exemplar of the Controlled Instrument such as described above.
2. An exemplar of a Target Instrument such as described above, whose acoustic properties have to be imitated by the Controlled Instrument.
3. A pressure measurement apparatus s₂ (301), such as a condenser microphone, placed in the proximity of the instrument to capture the radiated acoustic pressure.
4. An Analog-to-Digital converter (ADC2) (302) used to sample and quantize the pressure signal coming from the microphone s₂ (301).
5. A generic Central Processing Unit (CPU2) (303) used to run the calibration algorithm for deriving the parameters of the control algorithm which runs in CPU1 (207).

### 4.1 Mathematical Modelling of the Controlled and Target Instruments

In this section we characterise the mathematical modelling of the Controlled and Target Instruments, which is the essential preliminary step to specify the Control Algorithm in the next section.

Following a classic approach in control systems theory, the input/output relationships of the Controlled Instrument, and the Target Instrument, are detailed respectively in FIG. 1.4. Each solid block (402) (403) (404) (405) (406) (407) represents a frequency response function (FRF) that models a mechanical or acoustical property of the considered instrument, with the exception of the blocks K₁(ω) (404), K₂(ω) (407) that correspond to functions implemented by the digital controller. These functions (404) (407) are the control parameters of the Control Algorithm that we can choose so to have desired vibrations of the Controlled Instrument. The position of both the sensors (203) (301) and actuators (204) (205) are explicated through dashed boxes for clarity purposes, while their input/output behaviour is lumped into the transfer functions that model the physical system.

The physical variables explicited on the signal branches are the following:
U(ω) (408) is a vector whose components are the force signals generated by the Nₛ strings (409) of the instrument as the result of the excitation of the human player and acting on the bridge that couples the strings to the soundboard.
V(ω) (410) is the velocity of the soundboard in the proximity of the bridge measured by sensor s₁ (203).
Y_{c}(ω) (411) is the acoustic pressure generated by the principal part of the body instrument as measured by sensor s₂ (301).
Yₜ(ω) (412) is the acoustic pressure generated by the secondary tone chamber as measured by sensor s₂ (301).
Y(ω) (413) is the total pressure measured by sensor s₂ (301) as the combined action of the principal body and the tone chamber.

The frequency response functions corresponding to mechanical and acoustical parts of the Controlled Instrument and the estimation procedures for their parameters are the following:
H_{c}(ω) (402) is the mechanical impedance of the instrument body to the exciting action of the strings. Mathematically it is a row vector of dimension 1×Nₛ whose columns are the FRFs from the forces generated by each string and the velocity measured at sensor s₁ (203). The FRFs of each column can be measured applying the wire break technique (Woodhouse 2004) to string having index n, 1≤n≤Nₛ, while other strings are temporarily removed from the instrument. The recorded velocity signal measured at sensor s₁ (203) is taken as the impulse response h_{c,n}(t) and its Fourier Transform H_{c,n}(ω) is the n-th column of H_{c}(ω) (402).

H₁(ω) (403) models the combined action of the response of the actuator a₁ (204) and the mechanical impedance of the instrument body excited in the position of the actuator. It can be measured by feeding the actuator a₁ with a test signal such as a Logarithmic Sinusoidal Sweep (LSS) or a Maximum Length Sequence (MLS), recording the output signal measured with sensor s₁ (203) and using standard system estimation techniques such as, and not limited to, Least Squares Optimization.
A_{c}(ω) (405) models the acoustic radiation impedance of the main body of the instrument. It can be measured by feeding the actuator a₁ (204) with a test signal (LSS or MLS) and recording the output recorded by pressure sensor s₂ (301).
Aₜ(ω) (406) is a lumped model of the response of the actuator a₂ (205), the mechanical impedance and the acoustic radiation impedance of the separate tone chamber. It can be measured by feeding the actuator a₁ (204) with a test signal (LSS or MLS) and recording the output recorded by pressure sensor s₂ (301).
K₁(ω) (404), K₂(ω) (407) are the FRFs of two separate computational blocks that represent the digital LTI systems implemented by the algorithms in the CPU1 (207).

With basic algebra manipulations, the overall matrix of FRFs G(ω) (502) of the Controlled Instrument system can be derived as

$$G ( ω ) = \frac{Y ( ω )}{U ( ω )} = \frac{[ {A}_{t} ( ω ) {K}_{2} ( ω ) + {A}_{c} ( ω ) ] {H}_{c} ( ω )}{1 - {H}_{1} ( ω ) {K}_{1} ( ω )} . \qquad ( 4.1 )$$

The n-th component of G(ω) (502), referred to as Gₙ(ω), models the FRF from the n-th string to the pressure sensor s₂ (301).

### 4.2 Control Algorithm

The Control Algorithm is based on a mathematical model of the Controlled Instrument we described in the previous section, which is the acoustic system under control. Such an algorithm is representable as a pair of discrete-time Linear Time Invariant (LTI) systems that are specified by K₁(ω) (404), K₂(ω) (407), respectively, and that are implemented by a microprocessor. The algorithm's behaviour consists of two main parts: (i) the creation of the resonances that are not present among those naturally producible by the Controlled Instrument (i.e., those resonances that could not be produced without using a Control Algorithm); (ii) the cancellation of the resonances that are present among those produced by the Controlled Instrument.

Since there are many ways to choose K₁(ω) (404), K₂(ω) (407), one may have several instances of the Control Algorithm. Each instance has its own implementation complexity. Finding a set of parameters for an instance of the Control Algorithm can be seen as an optimization problem, where the goal is to minimize in the frequency domain the weighted squared error E (604) between the Controlled Instrument's frequency response G(ω) (401) and the desired frequency response D(ω) (602). The weighting function W(ω) 605 is arbitrarily chosen using e.g. a psycho-acoustic function that tries to give more importance to the frequency region that are most important for the human ear. In the following, the most general instance is specified (the Multi-Objective Control Algorithm), and then some special cases are provided.

### 4.3 Multi-Objective Control Algorithm

Let D(ω) (602) be a desired FRF, namely a FRF that the Controlled Instrument has to exhibit so that it can produces the desired vibrations. The algorithm consists in specifying the control blocks K₁(ω) (404), K₂(ω) (407) so that the FRF of the Controlled Instrument G(ω) (401), specified in Eq. (4.1), is as much close as possible to the desired FRF D(ω) (602). Since the FRF is a matrix of complex numbers, we need to specify in which sense the two FRF are made equal. This is complicated by that we are dealing with complex numbers.

Let M_{D}(ω) be the matrix whose entries are the modules of the entries of the matrix D(ω) (602), and let Φ_{D}(ω) the matrix whose entries are given by the phases of the entries of the matrix D(ω) (602). Analogously, let M_{G}(ω) be the matrix whose entries are the modules of the entries of the matrix G(ω) (401), and let Φ_{G}(W) the matrix whose entries are given by the phases of the entries of the matrix G(ω) (401). Moreover, let ∥·∥ be any induced matrix norm, for example 1-norm, 2-norm, Frobenius-norm, oc-norm, max-norm, or min-norm, to mention some of the possibilities.

The most general way consists in choosing K₁(ω) (404), K₂(ω) (407) by a multi-objective optimisation so that the integral over the frequency domain of a weighted squared induced norm of the matrix difference among M_{D}(ω) and M_{G}(ω) is as small as possible, while the integral over the frequencies of a weighted squared induced norm of the matrix difference among Φ_{D}(ω) and Φ_{G}(ω) is as small as possible. Additionally, this optimisation has to ensure that the choice of K₁(ω) (404), K₂(ω) (407) give a FRF matrix G(ω) must be BIBO (Bounded-Input, Bounded-Output) stable. Otherwise, the resulting system would present self-sustained oscillations due to errors in feedback control, which are usually referred to as “Larsen effect” by musicians. The constraint can be satisfied by exploiting well-known results in control systems theory concerning poles and zero placements of FRF. Formally, we have the following multi-objective optimisation problem:

$$\begin{matrix}{min}_{{K}_{1} ( ω ) , {K}_{2} ( ω )} [ \begin{matrix}{\int }_{0}^{{ω}_{max}} ‖ [ {M}_{D} ( ω ) - {M}_{G} ( ω ) ] {W}_{M} ( ω ) ‖ d ω \\ {\int }_{0}^{{ω}_{max}} ‖ [ {Φ}_{D} ( ω ) - {Φ}_{G} ( ω ) ] {W}_{Φ} ( ω ) ‖ d ω\end{matrix} ] & ( 4.2 ) \\ subject to BIBO stability of G ( ω ) . & ( 4.3 )\end{matrix}$$

In this optimisation problem, the weighing matrixes W_{M}(ω) and W_{Φ}(ω) are chosen arbitrarily. For example, they can be a psychoacoustic weighting function that gives more importance they can give more importance to the frequencies important for the human hearing system, such as A-weighting, ITU-R 468 or similar functions. The decision variabler of the optimisation problem are K₁(ω) (404), K₂(ω) (407). In the problem, ωₘₐₓ 229 is the maximal frequency of interest for the application, usually close to the human hearing frequency limit (e.g. 20,000/2π rad/s). Note that in the optimisation problem we have two objectives: the simultaneous minimisation of the module and the simultaneous minimisation of the phases. The solution of the optimisation problem can be obtained by any solution method for multi-objective optimisation. This should not be a problem, since the solution can be achieved off-line. Nevertheless, in the following, we present some other approaches that are of reduced computational complexity.

A computationally more affordable way to solve optimisation problem (4.2) is via a scalarizarion procedure that leads to a Pareto optimisation as follows: First, we define a secularised cost function weighted by the Pareto coefficient 0≤ρ≤1:

p(K₁(ω),K₂(ω))=∫₀^{ω}^{ₘₐₓ}{ρ∥[M_{D}(ω)−M_{G}(ω)]W_{M}(ω)∥+(1−ρ)∥[Φ_{D}(ω)−Φ_{G}(ω)]W_{Φ}(ω)∥}dω. (4.4)

Then, the Control Algorithm parameters are give by the solution to the following optimisation problem:

min_{K}_{₁}_{(ω)K}_{₂}_{(ω)} p(K₁(ω),K₂(ω)) (4.5)

subject to BIBO stability of G(ω). (4.6)

Note that in this optimisation problem, the choice of the coefficient ρ is left to the implementer. For example, one could even choose ρ=1 so to give no relevance to the phase minimisation. Alternatively, it can be done by constructing the standard Pareto trade-off curve and looking for the knee-point of the courve. Finally, observe that if optimisation problem (4.2) is convex in the decision variables K₁(ω) (404), K₂(ω) (407), then the optimal solution returned by (4.5) is identical to the one returned by (4.2). However, if problem (4.2) is non convex, then the solution of problem (4.5) is a feasible solution for problem (4.2) and in general is sub-optimal for problem (4.2).

### 4.4 Multi-Objective Sub-Optimal Control Algorithm

The methods to determine the values of K₁(ω) (404), K₂(ω) (407) can be computational demanding. Here, we describe a sub-optimal method that is of easier implementation. This method is sub-optimal compared to the more general method given by optimisation problems (4.2) and (4.5).

Once a desired FRF D(ω) (602) is set, the Multi-Objective Sub-Optimal Control Algorithm consists in finding the control blocks K₁(ω) (404), K₂(ω) (407) that simultaneously minimise the squared error between the spectral magnitudes of the controlled and target FRFs, where the errors are defined component-wise:

Eₙ=∫₀^{ω}^{ₘₐₓ}|Gₙ(ω)−Dₙ(ω)|²Wₚ(ω)dω, 1≤n≤Nₛ, (4.7)

where ωₘₐₓ is the maximal frequency of interest for the application, as for the previous problems, and Wₚ(ω) is a psychoacoustic weighting function that gives more importance to the frequencies relevant for the human hearing system, such as A-weighting, ITU-R 468 or similar functions. The optimization is subjected to the constraint that the resulting system defined by G(ω) (401) must be BIBO (Bounded-Input, Bounded-Output) stable. The optimisation problem is

$$\begin{matrix}{min}_{{K}_{1} ( ω ) , {K}_{2} ( ω )} [ \begin{matrix}{E}_{1} \\ {E}_{2} \\ ⋮ \\ {E}_{n}\end{matrix} ] & ( 4.8 ) \\ subject to BIBO stability of G ( ω ) . & ( 4.9 )\end{matrix}$$

As for the previous section, the solution to this problem can via standard multi-objective optimisation methods. A computationally simple method of finding a feasible solution, which is optimal if the problem is convex, is by Pareto scalarization, where the solution to (4.8) is achieved by solving the following Pareto optimisation problem

$$\begin{matrix}{min}_{{K}_{1} ( ω ) , {K}_{2} ( ω )} {\sum }_{i = 1}^{n} {ρ}_{i} {E}_{i} & ( 4.10 ) \\ subject to BIBO stability of G ( ω ) & ( 4.11 ) \\ 0 \leq {ρ}_{i} \leq 1 ∀ i & ( 4.12 ) \\ {\sum }_{i} {ρ}_{i} = 1. & ( 4.13 )\end{matrix}$$

Note that in this problem, the choice of the Pareto weighting coefficients ρᵢ is left to the implementer. Alternatively, one can draw the usual Pareto trade-off curve and choose the ρᵢ that give the knee-point.

### 4.5 Multi-Objective Heuristic Control Algorithm

Here we propose a simpler method to determine K₁(ω) (404), K₂(ω) (407). The method is heuristic in the sense that it is not analytically derived from the approach of the previous section, although it is inspired from it. Here, the determination of the values of K₁(ω) (404), K₂(ω) (407) consists of two steps. First, the parameters of the controller K₂(ω) (407) are estimated exploiting that the actuator a₂ (205) is placed in an independent tone chamber. In this way it is possible to reproduce, in the Controlled Instrument, the acoustic resonances that are given by D(ω) (602) but not in the Controlled Instrument itself when both the actuators are not active. In a formal way, the feed-forward FRFs of the Controlled Instrument when only actuator a₂ (205) is active, is defined as:

\tilde{G}_{2,n}(ω)=[Aₜ(ω)K₂(ω)+A_{c}(ω)]H_{c,n}(ω). (4.14)

In the first step, an optimization problem is posed to find only the controller K₂(ω) (407) that minimize the weighted target error functions E_{t,n} defined as

E_{t,n}=∫₀^{ω}^{ₘₐₓ}|\tilde{G}_{2,n}(ω)−Dₙ(ω)|²(|Dₙ(ω)|/|\tilde{G}_{2,n}(ω)|)^{β}^{ₜ}Wₚ(ω)dω, (4.15)

where the exponent βₜ>1 controls the weight given to the frequency points where the spectral magnitude |Dₙ(ω)| is larger than |\tilde{G}_{2,n}(ω)|. In other words, the error E_{t,n} 282 is subjected to an additional weight that gives more relevance to the frequency points where target response has resonances that are not present in the Controlled Instrument's response. At the same time, less effort is spent trying to suppress resonances that are present in the Controlled Instrument but not in the Target Instrument. Formally, the optimisation problem posed to determine K₂(ω) (407) is

$$\begin{matrix}{min}_{{K}_{2} ( ω )} [ \begin{matrix}{E}_{t , 1} \\ {E}_{t , 2} \\ ⋮ \\ {E}_{t , n}\end{matrix} ] & ( 4.16 ) \\ subject to BIBO stability of {\tilde{G}}_{2 , n} ( ω ) . & ( 4.17 )\end{matrix}$$

As for the previous section, the solution to this problem can via standard multi-objective optimisation methods. A computationally simple method of finding a feasible solution, which is optimal if the problem is convex, is by Pareto scalarization, where the solution to (4.16) is achieved by solving the following Pareto optimisation problem

$$\begin{matrix}{min}_{{K}_{2} ( ω )} {\sum }_{i = 1}^{n} {ρ}_{i} {E}_{t , i} & ( 4.18 ) \\ subject to BIBO stability of {\tilde{G}}_{2 , n} ( ω ) & ( 4.19 ) \\ 0 \leq {ρ}_{i} \leq 1 ∀ i & ( 4.20 ) \\ {\sum }_{i} {ρ}_{i} = 1. & ( 4.21 )\end{matrix}$$

Let denote by K₂*(ω) the solution to this problem, namely K₂*(ω) is the transfer function of the calibrated controller that drives the actuator a₂ (205) computed as the result of the first step of the algorithm.

If we now use K₂*(ω), the overall FRFs of the Controlled Instrument depends now only on K₁(ω) (404), and results defined as

$${\tilde{G}}_{1 , n} ( ω ) = \frac{[ {A}_{t} ( ω ) {K}_{2}^{*} ( ω ) + {A}_{c} ( ω ) ] {H}_{c , n} ( ω )}{1 - {H}_{1} ( ω ) {K}_{1} ( ω )} . \qquad ( 4.22 )$$

Then, we can determine K₁(ω) (404) by formulating an optimisation problem that minimizes the overall resulting error:

E_{r,n}=∫₀^{ω}^{ₘₐₓ}|\tilde{G}_{1,n}(ω)−Dₙ(ω)|²(|Gₙ|/|\tilde{G}_{1,n}|)^{β}^{ᵣ}Wₚ(ω)dω, (4.23)

where 0<βᵣ<1 is the exponent that weights the effort towards the suppression of the unwanted resonances in the Controlled Instrument's response and, at the same time, simplify the task of designing a controller that maintains the constraint of BIBO stability. Formally, the optimisation problem posed to determine K₁(ω) (404) is

$$\begin{matrix}{min}_{{K}_{1} ( ω )} [ \begin{matrix}{E}_{r , 1} \\ {E}_{r , 2} \\ ⋮ \\ {E}_{r , n}\end{matrix} ] & ( 4.24 ) \\ subject to BIBO stability of {\tilde{G}}_{1 , n} ( ω ) . & ( 4.25 )\end{matrix}$$

As for the optimisation problem of the first step, the solution to this problem can be done via standard multi-objective optimisation methods. A computationally simple method of finding a feasible solution, which is optimal if the problem is convex, is by Pareto scalarization, where the solution to (4.24) is achieved by solving the following Pareto optimisation problem

$$\begin{matrix}{min}_{{K}_{1} ( ω )} {\sum }_{i = 1}^{n} {α}_{i} {E}_{r , i} & ( 4.26 ) \\ subject to BIBO stability of {\tilde{G}}_{1 , n} ( ω ) & ( 4.27 ) \\ 0 \leq {α}_{i} \leq 1 ∀ i & ( 4.28 ) \\ {\sum }_{i} {α}_{i} = 1. & ( 4.29 )\end{matrix}$$

Let denote by K₁*(a)) the solution to this problem, namely K₁*(a)) is the transfer function of the calibrated controller that drives the actuator a₁ (204) computed as the result of the second step of the algorithm.

### 4.6 Cloning Procedure

The Cloning Procedure provides the Control Algorithm with the parameters that regulate actuators of the Controlled Instrument when the Control Algorithm allows the reproduction of the vibrations of the Target Instrument. Otherwise, the Control Algorithm can have its parameters set so that the Controlled Instrument can reproduce any desired vibration. The Control Algorithm's behaviour for cloning a Target Instrument consists of two main parts: (i) the creation of the resonances that are not present among those naturally producible by the Controlled Instrument (i.e., those resonances that could not be produced without using a Control Algorithm), but that are present in the Target Instrument's timbre; (ii) the cancellation of the resonances that are present among those produced by the Controlled Instrument, but that are not present in the Target Instrument's timbre.

The objective of the Control Algorithm for cloning a Target Instrument is the imitation of the acoustic properties of a given target acoustic musical instrument by finding a proper set of parameters for the controllers K₁(ω) (404), K₂(ω) (407). A block diagram for the model of the Target Instrument is presented in FIG. 1.5. Input and output variables are the same as for the Controlled Instrument, i.e., the force vector U(ω) (408) generated at the bridge by the strings and the acoustic pressure Y(ω) (413) measured with sensor s₂ (301). The lumped matrix frequency response G*(ω) (502) of the Target Instrument can be estimated by the means of the wire break technique, pulling each string of index n until breakdown and taking the recorded acoustic pressure gₙ*(t) at sensor s₂ (301) as the n-th impulse response. By taking the Fourier Transform of the impulse responses for each n the matrix G*(ω) (502) is finally assembled.

The Cloning Procedure is then finalised by imposing that D(ω) (602)=G*(ω) (502) and applying any Control Algorithm of the previous section.

### 4.7 References Cited

US2002/0005108A1
PCT/GB2000/000769
U.S. Pat. No. 6,320,113 B1
U.S. Pat. No. 8,389,835 B2
Woodhouse, Jim. “Plucked guitar transients: Comparison of measurements and synthesis”. Acta Acustica united with Acustica 90.5 (2004): 945-965.

What is claimed is:

1) A method and a process to shape and control in real-time the acoustic response of a controlled instrument such to obtain a desired timbre and/or tone specified by a given target acoustic response, such method characterized by:
a) a Controlled Instrument, preferably a stringed musical instrument capable of producing sound waves comprising a radiating body capable of vibration (101), a bridge (103), and strings (104). Such radiating body (101) divided into a principal part (201) and a secondary tonal chamber (202), such secondary tonal chamber being of smaller dimensions than the principal part (201) and being mechanically loosely coupled from the rest of the instrument;
b) a mechanical frequency response H_{c} (402) and an acoustic frequency response A (409) originated by the principal part (201) of such Controlled Instrument;
c) a measurement apparatus s₁ (203), placed in the principal part of the body of the Controlled Instrument (201) in a position close to the strings bridge (103), and such measurement apparatus (203) capable of reading the vibration of such Controlled instrument (201) and converting said vibration to an electronic signal;
d) a tonal acoustic chamber (202), characterized by an acoustic frequency response A (406), which is mechanically independent and insulated from the rest of the body of the Controlled Instrument (201);
e) number 2 force actuators (204) (205) or other comparable vibratory devices such as moving magnetic actuators or piezoelectric transducers capable of providing mechanical excitation coupled to said radiating body (201), the first force actuator a₁ (204) placed in the principal part of the body (201) close to the measurement apparatus (203) and whose frequency response being characterized by the function H₁ (403); the second force actuator a₂ (205) placed in the secondary tone chamber (202) and having an acoustic frequency response Aₜ (406); both actuators (204) and (205) being in communication with a controller (209) and configured to receive electrical signals and alter the vibration of said radiating bodies at the actuators locations (204) and (205);
f) a controller (209) in communication with the measurement apparatus (203), such controller including a processor (207) to process the measured electrical signals (410) in accordance with a real-time control system (401) which produces output electrical signals according to the implementation of two Linear Time Invariant discrete-time systems K₁ (404) and K₂ (407); wherein such processor (207) includes at least one of the devices selected from the group consisting of: a microprocessor, a microcontroller, or an application specific integrated circuit;
g) a mathematical model (401) of the controlled instrument, composed by the serial connection of the system described by the frequency response function H_{c} (402) and the system defined by the parallel connection of A_{c} (409) and the product of Aₜ (406) and K₂ (407) and having a feedback loop placed at the output of the measurement apparatus s₁ (203) defined by the serial connection of the frequency response functions K₁ (404) and H₁ (403);
h) an optimization procedure (601) which synthetically sets the pair of discrete time Linear Time Invariant (LTI) systems K₁ (404) and K₂ (407) according to a series of algebraic passages in such a way that the weighted squared error E (604) in the frequency domain between the desired response D (602) and the response of the controlled system G (401) is minimized; such algebraic passages specified in the following order:
h.1. compute the parameters of the Linear Time Invariant system K₂ (407) independently from K₁ (404), as a result of the assumption of claim 1.c), in order to minimize the error E (604) when the contribute of the system K₁ (404) in the feedback loop is assumed to be null using one of the known optimization techniques such as, and not limited to, the Least Square Method;
h.2. subsequently compute the parameters of the Linear Time Invariant system K₁ (404) starting from the resulting value of K₂ (407) obtained from the algebraic passage of h.1, and including the contribution of the feedback loop, using one of the known optimization techniques such as, and not limited to, the Least Square Method;

2) A Cloning Procedure consisting of a method and a process as in claim 1, wherein the target acoustic response D (602) might be measured from a given acoustic stringed instrument or Target Instrument (501) by means of one of the known acoustic measurement techniques such as, and not limited to, the wire break method.

3) A method and a process as in claim 1, which can be activated or deactivated independently from the usage of the Controlled Instrument (i.e. the Controlled Instrument will play as a standard acoustic instrument when the process is deactivated and generate the desired timbre when the process is activated).

4) A method and a process as in claim 1, wherein the optimization procedure of point h) is performed by simultaneously optimizing the acoustic responses of all the strings of the Controlled Instrument according to a set of target acoustic responses, one for each string.
